(19) United States
(12) Patent Application Publication
(10) Pub. No.: US 2013/0329706 A1
(43) Pub. Date: Dec. 12, 2013

(54) PREVENTING INTERFERENCE BETWEEN A FIRST MODEM (E.G. DECT) LOCATED IN PROXIMITY TO A RADIO MODEM OPERATING IN A TDM MODE (E.G. GSM)

(71) Applicant: Moshe Haiut, Ramat Gan (IL)

(72) Inventor: Moshe Haiut, Ramat Gan (IL)

(21) Appl. No.: 13/952,623

(22) Filed: Jul. 28, 2013

Related U.S. Application Data
(63) Continuation-in-part of application No. PCT/IL2011/000183, filed on Feb. 23, 2011.

(51) Int. Cl. H04W 24/02

(52) U.S. Cl. CPC H04W 24/02
USPC 370/336

(57) ABSTRACT

A method for preventing interference between a first modem and located in proximity to a radio modem operating in TDM mode the method may include: detecting by the first modem, wireless transmission from the radio modem operating in a TDM mode; wherein the detecting comprises processing RSSI values obtained during multiple time slots of multiple frames of the first modem; determining an operation pattern of the radio modem operating in a TDM mode according to the detected transmission;
predicting time slots in which the radio modem operating in a TDM mode is expected to receive according to the operation pattern;
determining transmission time slots of the first modem according to the time slots in which the radio modem operating in a TDM mode is expected to receive.

### FIELD OF THE INVENTION

The subject matter relates generally to synchronizing two communication modems, and more specifically to a method of preventing interference between two wireless communication modems located in proximity to each other.

### BACKGROUND OF THE INVENTION

Two collocated radio devices that use scheduled Rx & Tx time slots in TDM0 networks can avoid collisions or interference by coordinating to temporarily shift their allocated slots over the time axis. Such solution is preferred when the frequency bands of the two radio devices are too close to enable any solution in the frequency domain.

Most solutions for preventing interference between the two communication modems in the two radio devices are based on a wired interface between the two radio5 devices. The wired interface enables one or both of the radio devices to manage their Tx timings.

It is desired to solve the technical problem of interference while enabling the two radio devices to be portable and independent.

### SUMMARY

It is an object of the subject matter to disclose a method for preventing interference between a first modem located in proximity to a radio modem operating in a TDM mode the method, comprising detecting transmission from the radio modem operating in a TDM mode; determining an operation pattern of the radio modem operating in a TDM mode according to the detected transmission; predicting time slots in which the radio modem operating in a TDM mode is expected to transmit according to the determined operation pattern; determining transmission time slots of the first modem according to the time slots in which the radio modem operating in a TDM mode is expected to transmit.

In some cases, the radio modem operating in a TDM mode is a GSM modem.

In some cases, the first modem is a DECT modem.

In some cases, predicting the time slots in which the radio modem operating in a TDM mode is expected to transmit is based on a scheduled cycle.

In some cases, the length of the scheduled cycle is based on the time elapsing between a first time frame of the first telephone modem beginning in proximity to a beginning of a time frame of the radio modem operating in a TDM mode and a second time frame of the first modem is expected to begin in proximity to a beginning of a time frame of the radio modem operating in a TDM mode.

In some cases, the length of the scheduled cycle is 60 milliseconds.

In some cases, the method further comprises a step of detecting when the first modem is in a receiving mode before detecting transmission from a radio modem operating in a TDM mode. In some cases, detecting transmission from a radio modem operating in a TDM mode is based on RSSI measurements.

In some cases, the method further comprises a step of tracking time slots of the radio modem operating in a TDM mode to compensate for time drift between the radio modem operating in a TDM mode and the first modem.

In some cases, the operation pattern of the radio modem operating in a TDM mode comprises transmission of signals from the radio modem operating in a TDM mode.

In some cases, the operation pattern of the radio modem operating in a TDM mode comprises receipt of signals at the radio modem operating in a TDM mode. In some cases, the method further comprises a step of associating time slots of the first modem with time slots of the radio modem operating in a TDM mode.

It is another object of the subject matter to disclose a system for preventing interference between a first modem located in proximity to a radio modem operating in a TDM mode the method, comprising a detector for detecting transmission from the radio modem operating in a TDM mode; a processor for determining an operation pattern of the radio modem operating in a TDM mode according to the detected transmission; a timing module for predicting time slots in which the radio modem operating in a TDM mode is expected to transmit according to the determined operation pattern.

In some cases, the system further comprises a storage unit configured to store time stamps in which the radio modem operating in a TDM mode is expected to transmit signals. In some cases, the storage unit is configured to store time stamps in which the radio modem operating in a TDM mode is expected to receive signals.

There is provided a method for preventing interference between a first modem operating in Digital Enhanced Cordless Telecommunications (DECT) and located in proximity to a radio modem operating in a time division multiplex (TDM) mode the method, the method may include detecting by the first modem, wireless transmission from the radio modem operating in a TDM mode; wherein the detecting comprises processing received signal strength indicator (RSSI) values obtained during multiple DECT time slots of multiple DECT frames of the first modem; determining an operation pattern of the radio modem operating in a TDM mode according to the detected transmission; predicting time slots in which the radio modem operating in a TDM mode is expected to receive according to the operation pattern; and determining transmission time slots of the first modem according to the time slots in which the radio modem operating in a TDM mode is expected to receive.

The radio modem may be a GSM modem.

The processing may include updating each data sheet entry out of multiple data sheet entries to provide an updated data sheet entry by performing a weighted summation of (a) a current RSSI value that corresponds to the data sheet entry and (b) a current value of the data sheet entry.

The method may include detecting a GSM transmission of the radio modem by finding data sheet entries having values that form an imaginary line having slope of a predetermined value.

The predetermined slope is 1.84 DECT time slots per DECT frame.

The data sheet entries that form the imaginary line may be obtained over multiple update iterations of the entire data sheet.

The method may include defining DECT time slots that correspond to the data sheet entries that form the imaginary lines as DECT time slots during which the radio modem is expected to transmit.

The method may include calculating for each DECT time slots of a group of DECT frames out of the multiple DECT frames, an updated RSSI value that represents a weighted sum of RSSI values measured during multiple repetitions of the group of DECT frames.

The method may include finding an imaginary line that links peak updated RSSI values and exhibits a DECT frame to DECT time slot slope that substantially equals a predetermined slope.

The method may include a step of tracking time slots of the radio modem operating in a TDM mode to compensate for time drift between the radio modem operating in a TDM mode and the first modem.

The method may include allocating by the first modem two selectable transmission time slots for another communication and selecting a selected one of transmission time slots out of the two selectable transmission time slots such as not to occur when the radio modem operating in a TDM mode is expected to receive.

The method may include selecting the selected transmission time slot so that (a) a minimal distance of the selected transmission slot from any time slot during which the radio modem is expected to receive exceeds (b) a minimal distance of a non-selected transmission slot from any time slot during which the radio modem is expected to receive.

The first modem may be a DECT base station and the other communication is made to a DECT handset. The method may include receiving by the DECT handset signals during the two selectable time slots and ignoring information received by the DECT handset during one of the two selectable time slots.

The method may include not transmitting by the first modem information relating to the selecting of the selected transmission time slot. Thus—the DECT handset does not known in advance in which of the two selectable time slots the DECT base station transmitted and may be arranged to process the signals received in each of the selectable time slots, to determine (for example—based on signal to noise ratio) which time slots was used to transmit the signals by the DECT base station and may ignore the signals received during the other time slot. Alternatively, if the DECT base station transmits signals during both selectable time slots then the DECT handset can use signals received during both time slots (it may correlate the signals, perform averaging, perform error correction of signals received in one time slot based upon signals received during the other time slot or otherwise merge the information extracted from the signals received during the two selectable time slots.

The method may include associating time slots of the first modem with time slots of the radio modem operating in a TDM mode.

There may be provided a system for preventing interference between a first modem operating in Digital Enhanced Cordless Telecommunications (DECT) and located in proximity to a radio modem operating in a TDM mode. The system may include a detector for detecting wireless transmission from the radio modem operating in a TDM mode; a processor for determining an operation pattern of the radio modem operating in a TDM mode according to the detected transmission processing received signal strength indicator (RSSI) values obtained during multiple DECT time slots of multiple DECT frames of the first modem; a timing module for predicting time slots in which the radio modem operating in a TDM mode is expected to receive according to the determined operation pattern and for determining transmission time slots of the first modem according to the time slots in which the radio modem operating in a TDM mode is expected to receive.

The processor may be arranged to detect detected transmission which is GSM compliant.

The processor may be arranged to update each data sheet entry out of multiple data sheet entries to provide an updated data sheet entry by performing a weighted summation of (a) a current RSSI value that corresponds to the data sheet entry and (b) a current value of the data sheet entry.

The processor may be arranged to detect a GSM transmission of the radio modem by finding data sheet entries having values that form an imaginary line having slope of a predetermined value.

The predetermined slope may be 1.84 DECT time slots per DECT frame.

The data sheet entries that form the imaginary line are obtained over multiple update iterations of the entire data sheet.

The timing module may be arranged to define DECT time slots that correspond to the data sheet entries that form the imaginary lines as DECT time slots during which the radio modem is expected to transmit.

The processor may be arranged to calculate for each DECT time slots of a group of DECT frames out of the multiple DECT frames, an updated RSSI value that represent a weighted sum of RSSI values measured during multiple repetitions of the group of DECT frames.

The processor may be arranged to find an imaginary line that links peak updated RSSI values and exhibits a DECT frame to DECT time slot slope that substantially equals a predetermined slope.

The processor may be arranged to track time slots of the radio modem operating in a TDM mode to compensate for time drift between the radio modem operating in a TDM mode and the first modem.

The timing module may be arranged to allocate two selectable transmission time slots for another communication and select a selected one of transmission time slots out of the two selectable transmission time slots such as not to occur when the radio modem operating in a TDM mode is expected to receive.

The timing module may be arranged to select the selected transmission time slot so that (a) a minimal distance of the selected transmission slot from any time slot during which the radio modem is expected to receive exceeds (b) a minimal distance of a non-selected transmission slot from any time slot during which the radio modem is expected to receive.

The system may further include a DECT handset and wherein the first modem is a DECT base station; wherein the DECT handset may be arranged to receive signals during the two selectable time slots and ignore information received by the DECT handset during one of the two selectable time slots.

The first modem may be arranged not to transmit information relating to the selecting of the selected transmission time slot.

The processor may be arranged to associate time slots of the first modem with time slots of the radio modem operating in a TDM mode.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a communication environment comprising two wireless modems, according to some exemplary embodiments of the subject matter;

FIG. 2 shows a frame and time slots scheme of a DECT modem and a GSM modem, according to exemplary embodiments of the disclosed subject matter;

FIG. 3 shows a time slot scheme of a GSM modem and a DECT modem, according to exemplary embodiments of the disclosed subject matter;

FIG. 4 shows a system for preventing interference between a communication modem located in proximity to a radio modem operating in a TDM mode, according to exemplary embodiments of the disclosed subject matter;

FIG. 5 shows a method for preventing interference between a first modem located in proximity to a radio modem operating in a TDM mode, according to exemplary embodiments of the disclosed subject matter;

FIG. 6 shows a three-dimensional graph of noise in specific time slots, according to exemplary embodiments of the disclosed subject matter; and

FIG. 7 shows a three-dimensional graph of noise in specific time slots, according to exemplary embodiments of the disclosed subject matter.

### DETAILED DESCRIPTION

The disclosed subject matter is described below with reference to flowchart illustrations and/or block diagrams of methods and apparatus (systems) according to embodiments of the subject matter. It will be understood that each block of the flowchart illustrations and/or block diagrams, and combinations of blocks in the flowchart illustrations and/or block diagrams, can be implemented by computer program instructions.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

One technical challenge disclosed in the subject matter is to prevent interference between two communication modems located in proximity to each other. When one of the communication modems transmits in one time slot, as performed in a GSM modem, and the other modem device tries to receive data in a pre-selected time slot, the receiver of the other modem will experience interference in one index of frames only.

One technical solution of the disclosed subject matter is a method and apparatus for preventing the interferences disclosed above. The method comprises detecting transmissions of a wireless modem operating in Time Division Multiplexing (TDM) and determining an operation pattern of the wireless modem according to the detected transmissions and definitions related to the wireless modem. Such wireless modem may be a GSM modem or another cellular modem operating in TDM mode. After determining the operation pattern, the method further predicts time slots used by the wireless modem for transmissions or receipt of signal. The method may also comprise determining the time slots of the other modem in which interference is likely to happen. The method may also comprise determining when the other modem should operate. The other modem may be, for example, a DECT modem positioned in proximity to the wireless modem operating in TDM.

The method may include: (i) The DECT receiver uses RSSI measurements to map repeating interference phases in 60 ms subsequent intervals; (ii) A correlation search algorithm detects the GSM transmission existence and timing (by detecting energy peaks in constant phases); (iii) The DECT MAC establishes call over two alternative TDM channels. Remote DECT device transmits the same data over the two channels to provide Rx slot redundancy to the interfered side; (iv) The DECT device that is collocated with the GSM device only transmits on one slot every frame. A dedicated algorithm in its MAC selects the time slot for transmission (one out of the two alternative pre-defined TDM channels) so as not to interfere with the GSM receiver; and (v) The DECT receiver keeps tracking the timing GSM transmission slots so as to compensate for possible time drift between the two devices.

A period of 60 ms equals to 6 DECT frames and 13 GSM frames. When counting the DECT frames modulo 6, each DECT frame can be assigned to one of 6 DECT frame index, enumerated 0, 1, 2 . . . 5. If the GSM device transmits in one slot (constant one, out of 8 possible slots) and the DECT device tries to receive DECT data in a pre-selected slot (out of 12 receive slots), the DECT receiver will experience interference in one index of frames only (index 1 in the example in the next page). This can be proven by simulation, or via analysis—using the formula below the table in the next page.

The DECT receiver can detect the transmission timing by using a correlation sequence (over 6 DECT frames) and compensate for possible time drift. The GSM Rx slot timing can be located as it is always 3 slots ahead of the transmission slot.

It should be noted that the following description related to GSM and DECT modem for simplicity only. The method and apparatus of the disclosed subject matter may apply to any pair of communication modems positioned in proximity to each other. In some exemplary cases, at least one of the pair of communication modems is required to have a structured time slot configuration. For example, the GSM modem may have a structured time slot configuration in which signals are received at the second time slot and signals are transmitted at the fifth time slot. Alternatively, only the time elapsing between consecutive transmission and receipt of time slots and the time consumed by the time slots is required to be known to a device implementing the method of the disclosed subject matter. In a third alternative, any information enabling the device implementing the method of the disclosed subject matter to associate time slots of a first communication modem to time slots of a second communication modem positioned in proximity to the first communication modem is sufficient to implement the method disclosed herein.

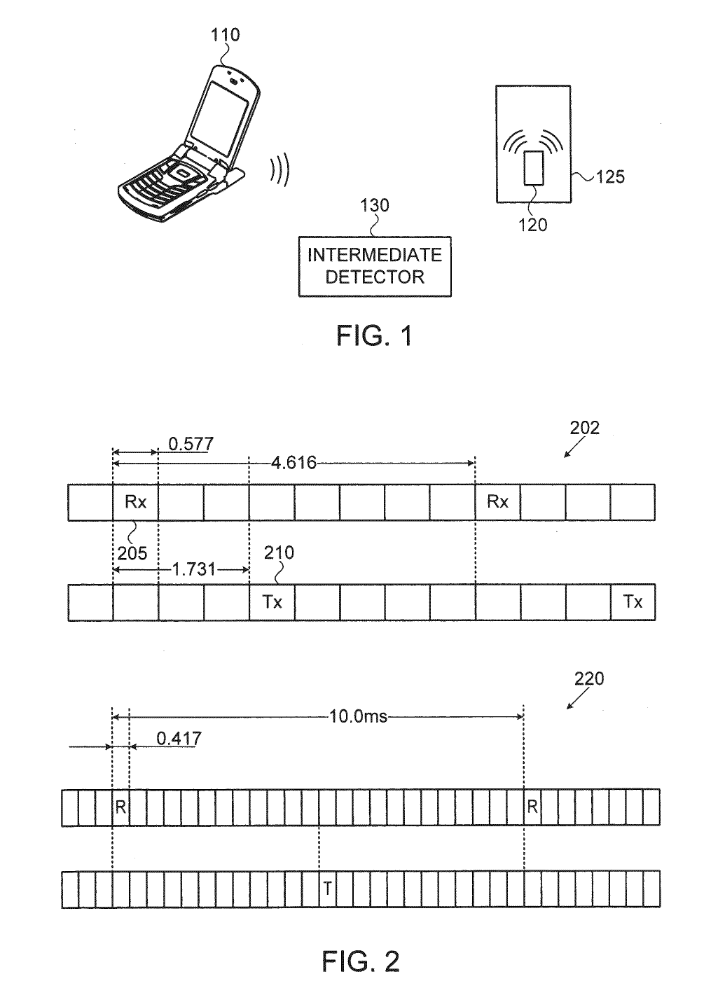

FIG. 1 shows a communication environment comprising two wireless modems, according to some exemplary embodiments of the subject matter. The communication environment comprises a GSM modem 110 and a cordless modem 120 positioned in a cordless device 125. Both the GSM modem 110 and the cordless modem 120 may transmit and receive signals in frequency bands allocated by authorities. For example, the cordless modem 120 may operate in a frequency band of 1921.5-1928.5 MHz and the GSM modem 110 may operate in a frequency band of 1850-1910 MHz for transmitting signals and a frequency band of 1930-1990 MHz for receiving signals. The GSM modem 110 and the cordless modem 120 are located in proximity to each other. Such proximity may be defined when both the GSM modem 110 and the cordless modem 120 are located in the same device or in different devices. The physical distance between the GSM modem 110 and the cordless modem 120 located in proximity may be up to several inches, or as long as one modem interferes with the operation of the other modem, for example, the GSM modem 110 interferes with the operation of the cordless modem 120.

The operation includes transmission of signals from the modems and receipt of signals at the modems.

The interference intensity of the GSM modem 110 to the cordless modem 120 and vice versa may be a function of the physical distance between the GSM modem 1 10 and the cordless modem 120 and the difference between the frequency used by the cordless modem 120 and the frequency used by the GSM modem 110. For example, when the cordless modem 120 is positioned 2 meters from the GSM modem 1 10 and the frequency difference between the channels used by the modems is 5 MHz, the intensity of interference is equivalent to a distance of 0.2 meters between the modems and frequency difference of 30 MHz. According to exemplary embodiments of the subject matter, at least one of the cordless modem 120 or the GSM modem 110 detects transmission or receipt of the other modem. In some exemplary cases, an intermediate detector 130 positioned in proximity to the cordless modem 120 or the GSM modem 110 detects transmissions or receipt of signals related to at least one of the cordless modem 120 or the GSM modem 110.

FIG. 2 shows a frame and time slots scheme of a DECT modem and a GSM modem, according to exemplary embodiments of the disclosed subject matter. A standard DECT communication frame 220 is 10 milliseconds long. Each DECT communication frame 220 comprises 24 time slots in which the DECT modem 120 transmits and receives signals. Each of the time slots of the DECT communication frame 220 is 0.417 milliseconds long. A standard GSM communication frame 202 is 4.616 milliseconds long. Such GSM communication frame 202 may be divided into 8 time slots. In this example, the second time slot 205 of the GSM communication frame 202 is allocated for receipt of signals while the fifth time slot 210 is allocated for transmission. It can be seen that if communication frames in a DECT modem and a GSM modem begin simultaneously, both modems will begin a time frame together once every 60 milliseconds, every 6 DECT communication frames 220 and every 13 GSM communication frames 202.

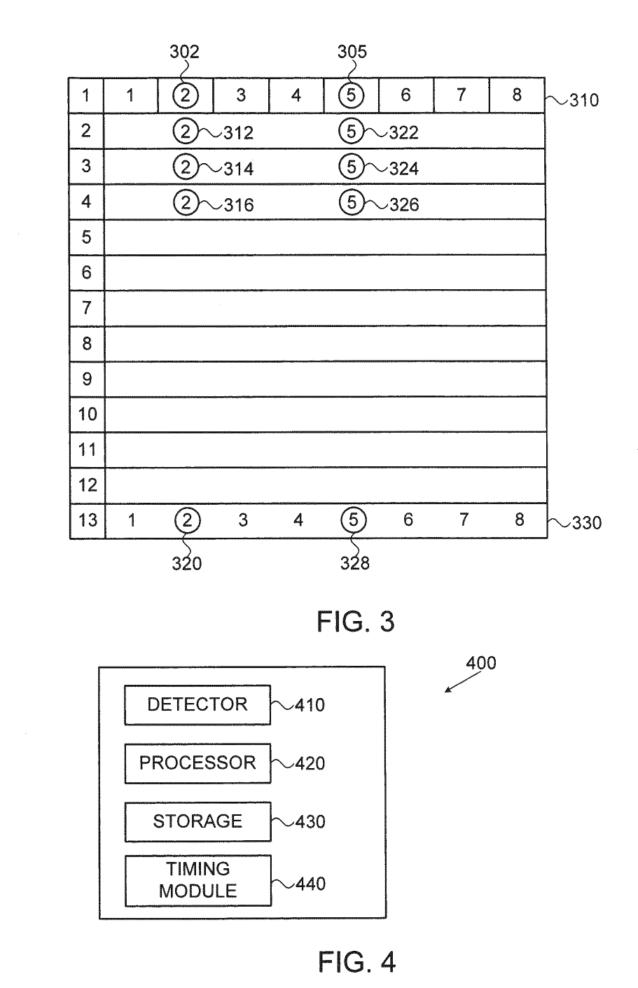

FIG. 3 shows a time slot scheme of a GSM modem and a DECT modem, according to exemplary embodiments of the disclosed subject matter. FIG. 3 shows thirteen GSM communication frames, similar to frames 202 of FIG. 2. Each GSM communication frame is 4.616 milliseconds long and comprises eight time slots allocated for transmission and receipt of signals. When a GSM communication frame begins simultaneously with a DECT communication frame, the next time in which a GSM communication frame will begin simultaneously with a DECT communication frame will be after 60 milliseconds. According to technical requirements of the GSM modem, the transmit time slot is located 3 time slots after the receive time slot. In some exemplary cases, the second time slot 302 of the first GSM communication frame 310 may be allocated for receipt of signals and the fifth time slot 305 of the first GSM communication frame 310 is allocated for transmission of signals.

Similarly, second time slots 312, 314, 316 up to second time slot 320 of the thirteenth GSM communication frame 330 are allocated to receipt of signals and fifth time slots 322, 324, 326 up to fifth time slot 328 of the thirteenth GSM communication frame 330 are allocated to transmission of signals at the GSM modem.

When detecting communication at the GSM modem, a computerized entity such as a software or hardware processor may predict future time stamps in which such communication is expected. For example, when detecting transmission of a signal at the GSM modem at the fifth time slot, a processor can predict reception of signals at the second time slot of the next GSM communication frame, 2.885 milliseconds later. Such 2.885 milliseconds is an example representing the difference between the beginning of a fifth GSM time slot and the beginning of a second GSM time slot.

Similarly, such computerized entity may predict allocated time slots in future GSM communication frames. For example, when detecting transmission of signals at the fifth time slot 305 of the first GSM communication frame 310, the computerized entity can predict receipt of signals at second time slots 312, 314, 316, and 320 of all future GSM communication frames.

Detection of transmitted signals at the GSM modem may be performed by detecting RSSI values. A person skilled in the art may select other detectable parameters to be detected from the GSM modem. Detection of transmission of signals from the GSM modem may be performed by a module residing at the DECT modem or by a unit communicating with and controlling the DECT modem.

FIG. 4 shows a system for preventing interference between a first modem located in proximity to a radio modem operating in a TDM mode, according to exemplary embodiments of the disclosed subject matter. System 400 may reside in the first modem or in a control unit located at least partially in proximity to the radio modem operating in a TDM mode. The system 400 may reside in a MAC layer of the first modem. The system 400 comprises a detector 410 for detecting operation of the radio modem operating in a TDM mode. In some cases, the radio modem operating in a TDM mode is a GSM modem. The detector 410 may detect signals related to the operation of the radio modem operating in a TDM mode. The detected signals may relate to transmission of signals from the radio modem operating in a TDM mode. Such signals may be represented by Received Signal Strength Indicator (RSSI) measurements. The detector 410 may comprise an antenna. The detector 410 may be an adaptive detector used for detecting signals at a predefined frequency band according to specifications of the radio modem operating in a TDM mode.

The system 400 may also comprise a processor 420 for receiving the RSSI level of the TDM radio modem from the detector 410. The processor 420 may also predict the RSSI level by inspecting the gain level of the AGC (Automatic Gain Control) in the receiver RF chain. The processor 410 can predict when the radio modem operating in a TDM mode is expected to operate according to the detected transmission of the radio modem operating in a TDM mode. The processor 420 may also use known definitions such as the communication protocol used by the radio modem operating in a TDM mode. Such communication protocol may define that the radio modem operating in a TDM mode transmits and receives signals at predetermined time differences. Because of the communication protocol definition, the processor 420 may predict when future transmission and reception of signals is expected at the radio modem operating in a TDM mode. The processor 420 may determine time stamps in which the radio modem operating in a TDM mode is expected to operate, for example, transmit or receive signals.

The system 400 may also comprise a storage unit 430. The storage unit 430 stores a set of rules used by the processor 420 in predicting future operation of the radio modem operating in a TDM mode. The storage unit 430 may also store time stamps in which the radio modem operating in a TDM mode is expected to transmit or receive signals. The storage unit 430 may further store data related to time slots of the DECT modem or time slots of the radio modem operating in a TDM mode. The storage unit 430 may further store a table or list associating a time slot of the radio modem operating in a TDM mode to a time slot of the DECT modem, for example associating a second time slot and a third time slot of the radio modem operating in a TDM mode to a fifteenth time slot of the DECT modem.

The system 400 may also comprise a timing module 440. The timing module 440 receives a time stamp related to the operation of the radio modem operating in a TDM mode from the processor 420. The timing module 440 further determines transmission time slots of the DECT modem. The timing module 440 determines when to activate transmission from the DECT modem. The timing module 440 may also determine when to change a time slot of the DECT modem when a time slot predicted to be used by the DECT modem has at least partial overlap time with a time slot expected to be used by the radio modem operating in a TDM mode.

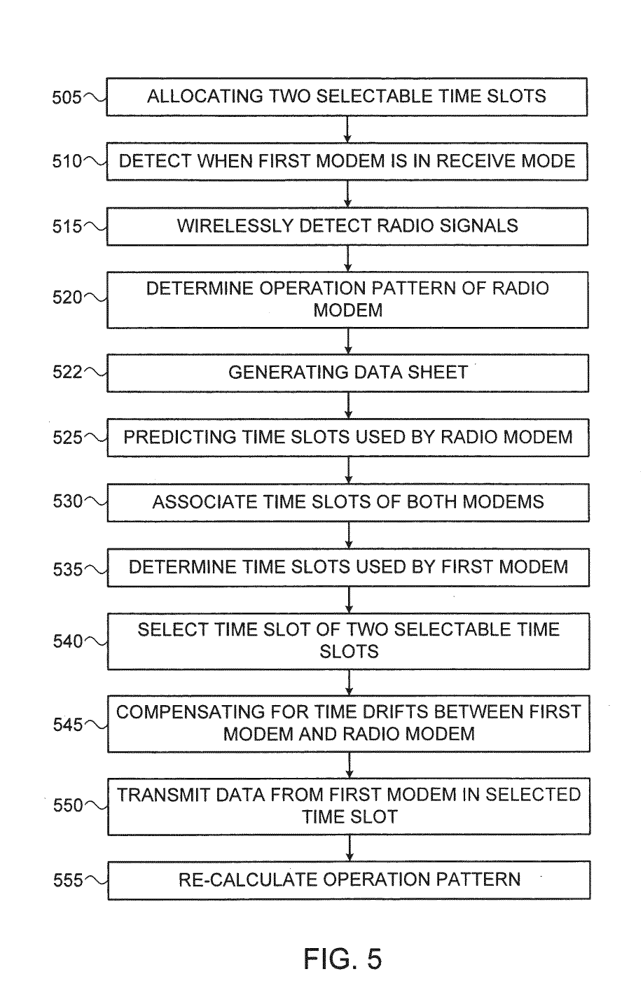

FIG. 5 shows a method for preventing interference between a first modem located in proximity to a radio modem operating in a TDM mode, according to exemplary embodiments of the disclosed subject matter. In step 505, the first modem allocates two selectable time slots for a specific communication frame. The first modem is in proximity to a radio modem operating in TDM mode. The two selectable time slots are used for the entire communication between the first modem and another communication. When predicting interference from radio modem operating in a TDM mode, communication from the first modem is performed in a time slot selected from the two selectable time slots.

In step 510, the first modem is detected to be in a receive mode. The first modem may have time slots allocated for receive mode at each communication frame. For example, when the first modem is a DECT modem such as DECT modem 120 of FIG. 1, the DECT communication frame comprises time slots allocated to receive signals, for example time slots 12-24 of the 24 time slots.

In step 515, radio signals of the radio modem operating in a TDM mode are detected. The detection may be performed by the first modem or by an intermediate detector positioned outside the first modem. The detected radio signals may be related to measured RSSI in the frequency band of the radio modem operating in a TDM mode, or calculated RSSI based on ACG gain level.

In step 520, an operation pattern of the radio modem operating in a TDM mode is determined. The operation pattern may be based on the detected signal and technical specification of the radio modem operating in a TDM mode. For example, such technical specification may be the length of a communication frame, the number of time slots in a communication frame and a length of a time slot and the indexes of transmission or receipt time slots in a communication frame. Such operation pattern may include time stamps in which the radio modem operating in a TDM mode transmits or receive signals. For example, when transmission of the radio modem operating in a TDM mode is detected in a time slot between millisecond 83.3 and millisecond 83.7, the pattern may indicate repetitive transmissions of frame-length time intervals. When the radio modem operating in a TDM mode is a GSM modem, the length of the communication frame is 4.616 milliseconds and the pattern is transmission for 0.577 milliseconds after pause of 4.039 milliseconds.

In step 522, a data sheet comprising time slots of the radio modem operating in a TDM mode and time slots of the first modem is generated, the data sheet may be a list, a table and the like. The data sheet may include time stamps associated with the time slots of the first modem, time stamps associated with the time slots of the radio modem operating in a TDM mode and the like. The data sheet may include radio signals of the radio modem operating in a TDM mode as detected in step 515. Such detected radio signals may be associated with a time slot of the first modem or associated with a time stamp. For example, RSSI value of 2 may be associated with the second time slot of the first DECT communication frame. The RSSI value may later be used to determine the time slot used by the first modem. The value associating detected radio signals and time slots of the first modem may be updated frequently. In some cases, updating the value associating detected radio signals and time slots of the first modem takes into account previously detected signals and currently detected signals. For example, using the formula Yn=a*Yn−1+Xn

In which Yn is the updated value in the data sheet, Yn−1 is the former value in the data sheet and Xn is a value representing currently detected signals, a is a constant, for example 0.7, representing the influence of the former value on the updated value. In some cases, values in the data sheet are updated every 60 milliseconds.

In step 525, time stamps used by the radio modem operating in a TDM mode are predicted. Such time slots may be the receiving time slot of a communication frame, having detecting transmission time slot when detecting radio signals in step 515. For example, when transmission of a GSM modem is detected in a time slot between millisecond 83.3 and millisecond 83.7, transmission is also predicted after 4.616 milliseconds, which is the length of a GSM communication frame. The time stamps may include 83.3 milliseconds plus 4.616, 83.3+2*4.616 and the like. In step 530, time slots of the radio modem operating in a TDM mode are associated with time slots of the first modem. Such association may result from a table or a timeline generated by the device implementing the method. For example, when a tenth time slot of the second communication frame of the first modem is expected to be between predefined milliseconds, the same predefined milliseconds may be allocated by two time slots of the modem operating in a TDM mode. Such two time slots may be, for example, the second and third time slots of a fourth communication frame of the modem operating in a TDM mode.

In step 535, time slots to be used by the first modem are determined. The time slots to be used by the first modem may be associated with time stamps associated with operation of the modem operating in a TDM mode. When the time slots of the first modem are not included in the time stamps predicted in step 525, the time slot may be determined for operation of the first modem.

In step 540, one time slot is selected from the two selectable time slots allocated in step 505. When two selectable time slots are allocated for operation of the first modem and the time stamp for operation of the modem operating in a TDM mode is determined, the selected time slot is the one more farther than the time stamp of operation of the modem operating in a TDM mode.

In step 545, time drifts between the first modem and the radio modem operating in a TDM mode are compensated. The time drifts may occur because of common physical variations between both modems. For example, the length of the communication frame in one of the modems may be slightly longer or shorter than required. As a result, periodical prediction of time slots in which operation is expected is required after the prediction performed in step 525. Such periodical prediction may take place every 300 milliseconds.

In step 550, the first modem transmits signals. Transmission of signals may be in the two selectable time slots allocated in step 505. Alternatively, only one time slot is selected for transmission as shown in step 540.

In step 555, the time slots determined for operation of the first modem are re-calculated.

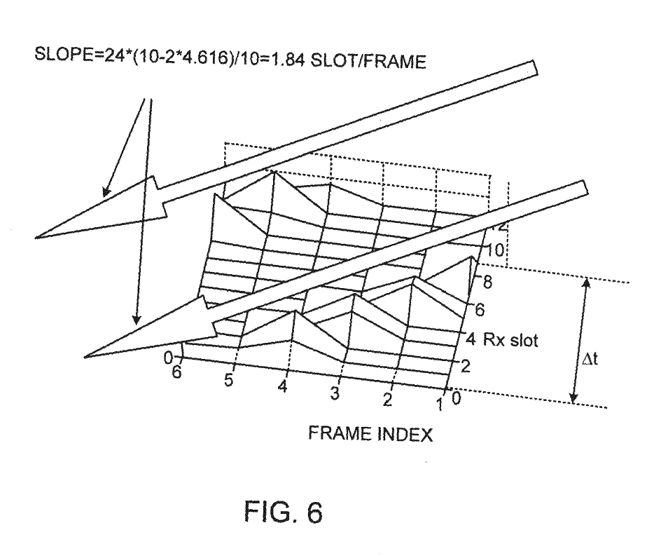

FIG. 6 shows a three-dimensional graph of noise in specific receive time slots, according to exemplary embodiments of the disclosed subject matter. This graph may also be referred to as a time sheet. It reflects values obtained during multiple repetitions of a group of DECT frames that include six DECT frames (see x-axis “Frame Index” that has values of 1-6), each of these DECT frames includes twelve receive DECT time slots (see y-axis that has values between 0 and 12). Accordingly—this graph has seventy two entries (seventy two data sheet values). The Z-axis of the graph represents the values of RSSI related variables (also referred to as data sheet entry values). The two arrows of FIG. 6 represent two imaginary lines that virtually connect peak values of the data sheet entries. It is noted that these two arrows can merge to a single arrow in certain occasions—for example if the first peak value appears in the twelfth receive DETC time slot of the first DECT frame (and not in the eighth DECT receive time slot of the first DECT frame).

These peak values can be obtained during multiple repetitions of the group of DECT frames—during a period of time that is a multiple integer of 60 milliseconds. The values of the RSSI can be calculated by using a weighted summation—as illustrated below.

Assuming no major interferers other than the modem operating in a TDM mode, the influence of the transmissions from the modem operating in a TDM mode on the values in the data sheet can be characterized by a reference timing At. The reference timing (At) can be any value between 0 and 12 DECT receive time slots, and represents the number of the receive DECT time slot in the first DECT frame, in which the modem operating in a TDM mode interferes with. In the second, third, forth, fifth, and sixth receive DECT frames of the data sheet, the number of the interfered DECT slot changes in a constant slope 1.84 in terms of [DECT slot/DECT frame] because of the ratio between the duration of GSM frame and DECT frame. For example, when time stamp in which the radio modem operating in a TDM mode is predicted to operate is in the eighths time slot of the first communication frame, the time slot of the next communication frame is the sixth (8−1.84˜6) time slot. The method uses the fixed slope value to perform a maximum likelihood search over the range (0, 12) of DECT receive time slots, in order to predict the reference timing At.

Slope=24*(10−2*4.616)/10=1.84 slot/frame

The predicted GSM reference timing at is re-calculated every 900 ms, using a maximum likelihood algorithm, assuming constant slop 1.84 slot/frame.

For example, the DECT transmitter toggles between transmit time slots 0 & 4 so as not to interfere with the GSM receive (Rx) slot. The algorithm first predicts the middle point of the next GSM Rx slot by using the predicted reference timing Δt and the fact that the GSM Rx slot appears exactly 3 GSM time-slots prior the GSM transmit (Tx) time-slot. Then, the preferred DECT Tx slot is selected so as to have the maximum time difference between the middle point of DECT Tx time slot and the middle point of predicted GSM Rx slot. In a similar way, the algorithm calculates which one of the two DECT Rx slots (12 & 16 in this example) may be interfered by the GSM Tx slot, and takes this into consideration when extracting the Rx data (At least one DECT Rx slot must contain valid data, also it is possible that both Rx slots are not interfered by GSM Tx and contain duplicated uncorrupted data as transmitted by the far-end DECT device).

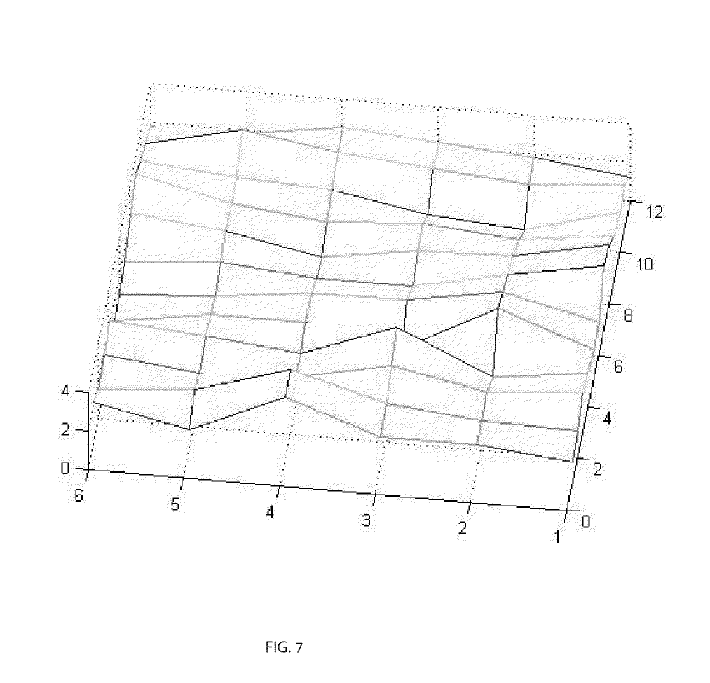

FIG. 7 shows a three-dimensional graph of noise in specific time slots, according to exemplary embodiments of the disclosed subject matter.

This graph represents a scenario in which there are additional interferences (not resulting from the radio modem) in the air. The algorithm may RSSI measurements that belong to time-slots that are occupied by the DECT network (for example—these RSSI measurement values can be zeroed to provide the graph of FIG. 6).

The flowchart and block diagrams in the Figures illustrate the architecture, functionality, and operation of possible implementations of systems, methods and computer program products according to various embodiments of the present subject matter. In this regard, each block in the flowchart or block diagrams may represent a module, segment, or portion of program code, which comprises one or more executable instructions for implementing the specified logical function(s).

As will be appreciated by one skilled in the art, the disclosed subject matter may be embodied as a system, method or computer program product.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

We claim:

1. A method for preventing interference between a first modem and located in proximity to a radio modem operating in a time division multiplex (TDM) mode the method, comprising:
detecting by the first modem, wireless transmission from the radio modem operating in a TDM mode; wherein the detecting comprises processing received signal strength indicator (RSSI) values obtained during multiple time slots of multiple frames of the first modem;
determining an operation pattern of the radio modem operating in a TDM mode according to the detected transmission;
predicting time slots in which the radio modem operating in a TDM mode is expected to receive according to the operation pattern;
determining transmission time slots of the first modem according to the time slots in which the radio modem operating in a TDM mode is expected to receive.

2. The method of claim 1, wherein the radio modem operating in a TDM modem is a GSM modem.

3. The method according to claim 2, wherein the first modem operates in Digital Enhanced Cordless Telecommunications (DECT) mode and wherein the multiple time slots of multiple frames are multiple DECT time slots of multiple DECT frames.

4. The method of claim 3, wherein the processing comprises updating each data sheet entry out of multiple data sheet entries to provide an updated data sheet entry by performing a weighted summation of (a) a current RSSI value that corresponds to the data sheet entry and (b) a current value of the data sheet entry.

5. The method of claim 4, comprising detecting a GSM transmission of the radio modem by finding data sheet entries having values that form an imaginary line having slope of a predetermined value.

6. The method of claim 5, wherein the predetermined slope is 1.84 DECT time slots per DECT frame.

7. The method of claim 5, wherein the data sheet entries that form the imaginary line are obtained over multiple update iterations of the entire data sheet.

8. The method according to claim 5, comprising defining DECT time slots that correspond to the data sheet entries that form the imaginary lines as DECT time slots during which the radio modem is expected to transmit.

9. The method of claim 3 comprising calculating for each DECT time slots of a group of DECT frames out of the multiple DECT frames, an updated RSSI value that represent a weighted sum of RSSI values measured during multiple repetitions of the group of DECT frames.

10. The method of claim 9, wherein comprising finding an imaginary line that links peak updated RSSI values and exhibits a DECT frame to DECT time slot slope that substantially equals a predetermined slope.

11. The method of claim 3, further comprises a step of tracking time slots of the radio modem operating in a TDM mode to compensate for time drift between the radio modem operating in a TDM mode and the first modem.

12. The method of claim 3, comprising allocating by the first modem two selectable transmission time slots for another communication and selecting a selected one of transmission time slots out of the two selectable transmission time slots such as not to occur when the radio modem operating in a TDM mode is expected to receive.

13. The method according to claim 12, comprising selecting the selected transmission time slot so that (a) a minimal distance of the selected transmission slot from any time slot during which the radio modem is expected to receive exceeds (b) a minimal distance of a non-selected transmission slot from any time slot during which the radio modem is expected to receive.

14. The method according to claim 12 wherein the first modem is a DECT base station and the other communication is made to a DECT handset; wherein the method comprises receiving by the DECT handset signals during the two selectable time slots and ignoring information received by the DECT handset during one of the two selectable time slots.

15. The method according to claim 12 comprising not transmitting by the first modem information relating to the selecting of the selected transmission time slot.

16. The method of claim 1, further comprises a step of associating time slots of the first modem with time slots of the radio modem operating in a TDM mode.

17. A system for preventing interference between a first modem and located in proximity to a radio modem operating in a TDM mode the system comprising:
a detector for detecting wireless transmission from the radio modem operating in a TDM mode;
a processor for determining an operation pattern of the radio modem operating in a TDM mode according to the detected transmission processing received signal strength indicator (RSSI) values obtained during multiple DECT time slots of multiple DECT frames of the first modem; and
a timing module for predicting time slots in which the radio modem operating in a TDM mode is expected to receive according to the determined operation pattern and for determining transmission time slots of the first modem according to the time slots in which the radio modem operating in a TDM mode is expected to receive.

18. The system of claim 17, wherein the first modem is arranged to operate in a Digital Enhanced Cordless Telecommunications (DECT) mode.

19. The system of claim 18, wherein the processor is arranged to detect detected transmission which is GSM compliant.

20. The system of claim 19, wherein the processor is arranged to update each data sheet entry out of multiple data sheet entries to provide an updated data sheet entry by performing a weighted summation of (a) a current RSSI value that corresponds to the data sheet entry and (b) a current value of the data sheet entry.

21. The system of claim 20, wherein the processor is arranged to detect a GSM transmission of the radio modem by finding data sheet entries having values that form an imaginary line having slope of a predetermined value.

22. The system of claim 21, wherein the predetermined slope is 1.84 DECT time slots per DECT frame.

23. The system of claim 21, wherein the data sheet entries that form the imaginary line are obtained over multiple update iterations of the entire data sheet.

24. The system according to claim 21, wherein the timing module is arranged to define DECT time slots that correspond to the data sheet entries that form the imaginary lines as DECT time slots during which the radio modem is expected to transmit.

25. The system of claim 19, wherein the processor is arranged to calculate for each DECT time slots of a group of DECT frames out of the multiple DECT frames, an updated RSSI value that represent a weighted sum of RSSI values measured during multiple repetitions of the group of DECT frames.

26. The system of claim 25 wherein the processor is arranged to find an imaginary line that links peak updated RSSI values and exhibits a DECT frame to DECT time slot slope that substantially equals a predetermined slope.

27. The system of claim 19 wherein the processor is arranged to track time slots of the radio modem operating in a TDM mode to compensate for time drift between the radio modem operating in a TDM mode and the first modem.

28. The system of claim 19, wherein the timing module is arranged to allocate two selectable transmission time slots for another communication and select a selected one of transmission time slots out of the two selectable transmission time slots such as not to occur when the radio modem operating in a TDM mode is expected to receive.

29. The system according to claim 28, wherein the timing module is arranged to select the selected transmission time slot so that (a) a minimal distance of the selected transmission slot from any time slot during which the radio modem is expected to receive exceeds (b) a minimal distance of a non-selected transmission slot from any time slot during which the radio modem is expected to receive.

30. The system according to claim 28 further comprising a DECT handset and wherein the first modem is a DECT base station; wherein the DECT handset is arranged to receive signals during the two selectable time slots and ignore information received by the DECT handset during one of the two selectable time slots.

31. The system according to claim 28 wherein the first modem is arranged not to transmit information relating to the selecting of the selected transmission time slot.

32. The system of claim 17 wherein the processor is arranged to associate time slots of the first modem with time slots of the radio modem operating in a TDM mode.
